(19) United States
(12) Patent Application Publication
(10) Pub. No.: US 2023/0048971 A1
(43) Pub. Date: Feb. 16, 2023

(54) SYSTEM AND METHOD FOR UTILIZING CHECKLISTS FOR LIFECYCLE MANAGEMENT IN A CASE MANAGEMENT SYSTEM

(71) Applicant: Open Text Holdings, Inc., San Mateo, CA (US)

(72) Inventors: Preetha Srinivasan, Bangalore (IN); Archana Arvind, Bangalore (IN); Ashalaxmi Gurumurthy, Bangalore (IN)

(21) Appl. No.: 17/402,843

(22) Filed: Aug. 16, 2021

(51) Int. Cl. G06Q 10/10; G06Q 10/06; G06F 40/20

(52) U.S. Cl. CPC G06Q 10/103; G06Q 10/06316; G06Q 10/06311; G06F 40/20

(57) ABSTRACT

Case management systems and techniques are disclosed. Specifically, embodiments of the case management systems and methods disclosed herein utilize checklists to manage the lifecycle of the cases of the case management system.

### TECHNICAL FIELD

This disclosure relates generally to case management in a distributed networked computing environment. More particularly, embodiments of this disclosure relates to managing the lifecycles of case instances in a case management system using checklists.

### BACKGROUND

Ever since the advent of the computer networks (including the Internet), enterprise environments have been steadily growing more complicated, encompassing an ever-expanding amount of increasingly complex digital content (or just content). Digital content, in essence, is anything that exists in a binary format that may exist in the enterprise environment or otherwise be utilized by the enterprise. The digital content of an enterprise may thus include a variety of digital assets including text, images, aural or video content, templates used in content delivery, objects, or other types of content. For purposes of this disclosure, the terms document and content will be used interchangeably and understood to have the same definition as digital content.

In an enterprise environment, these documents may be widely distributed and used for a wide variety of purposes in association with that enterprise. To aid in managing and using their various documents, many enterprises have employed a number of content management systems, such as digital asset management (DAM) systems, content management systems (CMS), web content management (WCM) systems, enterprise content management (ECM) systems, etc.

Once particular type of these systems is a case management system. Case management systems, software, or cloud-based or other electronically-provided case management services (collectively, “case management systems”) are used to automate the management of complex sets of documents or other content and associated processes comprising tasks that may be performed (e.g., utilizing the documents). Thus, these case management systems may be utilized with particular efficacy in situations in which the documents or other content that may need to be managed for respective particular instances of a case model may not be the same for each instance and the processing required or selected to be performed may not be the same for each instance. Examples of such situations include processing loan applications, insurance claims or medical records, though other examples are easily contemplated and may be applied to a wide variety of documents or tasks.

It is thus desirable to improve the functionality of such case management system with respect to the management of these cases.

### SUMMARY

To continue elaborating on the above referenced desires, as discussed case management systems may be utilized in situations in which content that may need to be managed for respective particular instances of a case model may not be the same for each instance and the processing required or selected to be performed may not be the same for each instance. Examples of such situations include processing loan applications, insurance claims or medical records, though other examples are easily contemplated and may be applied to a wide variety of documents or tasks. Case management may thus be thought of as a pattern of work common throughout many disciplines that requires a group of people to systematically collaborate using content and associated data.

In these case management systems, a case model typically describes a type of case, instances of which are to be managed by a case management system. A case may be thought of as a way of organizing documents (and, in some instances, the processes that are used to manage those documents). A case model is created at design time to create structure for the case (e.g., model for a set of folders). This structure is then created at runtime for an instance of the case when it is created. For example, the case model definition may include a hierarchical container model portion defining a hierarchical data model representing how case data is organized using a plurality of hierarchically related case nodes.

As opposed to very structured business process that defines a predetermined work flow that does not vary from instance to instance, using a case model one can model ad hoc actions and define responses thereto with workflows, enabling the processing of respective instances of a case model to be determined dynamically at runtime based, e.g., on events, context data, user input, dynamic evaluation of documents or other content, etc. As a result, each instance of a case model (e.g., the respective loan applications of different applicants or each individual employee) may follow its own course as determined at each step by processing (e.g., that may be defined in applicable portions of the case model).

Specifically, in certain cases, the processes that may be accomplished with respect to a type of case is defined by a lifecycle. The lifecycle may be thought of as a set of phases representing processes that may be performed in association with an instance of the case. These phases may have an ordered progression and a status associated with each phase. Thus, such a lifecycle may be defined for a type of case and may be included, for example, in the case model definition for a type of case. Accordingly, the lifecycle of a case instance at runtime may be managed by a corresponding lifecycle process created when a new case instance is created based on the lifecycle process defined at design time. Each case instance can thus be at a different (or same) phase of the lifecycle process. Each case instance can thus maintain a case status indicating the status of the phase that the case instance is in.

However, the use of these lifecycle processes is not without problems. In certain implementations, a user may be manually required to navigate between the different phases of a life cycle for a case instance, manually moving the case instance between the various phases and setting the case status on the case instance based on the phase of the lifecycle. Moreover the use of a defined lifecycle is problematic for other reasons. Typically, once the lifecycle for a case is defined it becomes difficult to implement changes or alterations to that lifecycle or, in general, to add additional processes to that type of case. Suppose, for example, that a user wishes to add a process to a case instance. If it is unrelated to the other phases of the lifecycle it may be desired to track the status of each case instance with respect to that process independently to the existing phases of the lifecycle. This tracking is difficult, as there may be only a single case status for the case instance, or may require the user to independently set two case status. Additionally, even if such a new phase is added to the existing lifecycle at a particular point in the lifecycle (e.g., between two sitting phases of the lifecycle), any case instance has progressed passed that point in the lifecycle will not go through that phase, or will require manual user intervention and involvement to reset that case instance to the point where it will undergo that newly added phase.

What is desired, therefore, are systems and method for case management that provide a more effective way of managing the lifecycle of case instances, including that ability to automatically move case instances between phase of a lifecycle and to introduce new processes to the lifecycle where those phases may be independently performed and have their status independently tracked with respect to each case instance.

To address those desires, among others, attention is now directed to embodiments of the case management systems and methods disclosed herein that utilize checklists to manage the lifecycle of the cases of the case management system. In certain embodiments, therefore, a lifecycle definition (also referred to just as a lifecycle) for a type of case may include a set of phases. These phases of a lifecycle may, for example, be independent and each associated with a status (e.g., indicating that phase).

A process can be defined for each of the phases (e.g., a user may define a process for a phase using a user interface or the like). For example, a user can use an interface to define a process using natural language or a combination of natural language with another method of defining a process (e.g., a library of steps or computer readable code, etc.). Based on the process for a phase, a checklist can be created for that phase, where the checklist includes a list of ordered tasks, where those tasks may be automated or manual. The checklist for a phase may be associated with an initiating event which will cause the (e.g., automatic) execution of the checklist. These initiating events may be associated with a case status of a case instance. The phases of a lifecycle can be ordered, or sequenced, by associating the checklist with initiating events corresponding to other phases (e.g., previous phases). For example, an initiating event of a first phase (or first task of a first phase) of a lifecycle may be associated with the creation of a case instance or a particular status being associated with a case instance, an initiating event of one checklist may be associated with a task (e.g., a last task) of the checklist of a previous phase, or a last task of a checklist of a phase may be associated with subsequent phase of the lifecycle.

In this manner, each phase of the lifecycle may be associated with an independent process (e.g., a checklist) that includes a set of ordered task and an initiating event. Thus, when a case instance of a case model is created a lifecycle corresponding to that case instance may be initiated by automatically initiating the execution of the checklist for the first phase of the lifecycle (e.g., any phase or checklist which has an initiating event defined as the creation of a case instance). In other words, the creation of a case instance may be allowed to trigger the lifecycle for that case instance. Additionally, a case status of the case instance may be set to indicate the case status associated with the executing phase of the lifecycle. In some embodiments, when each of the set of ordered tasks of the checklist of an executing phase is completed a completed indicator for that task may be stored in association with the case instance, wherein a (e.g., subsequent) task may not be indicated as completed until the previous task of the set of ordered tasks of the checklist is indicated as completed. In this way the ordered execution of the tasks of a checklist may be ensured or verified.

When the last task of the ordered set of tasks of the checklist is completed, if the last task of the checklist is associated with any subsequent phase, that execution of the checklist associated with that subsequent phase may be automatically initiated for that case instance, and the case status of the case instance updated to indicate the case status associated with that subsequent checklist. For example, if an initiating event of a checklist for a phase is a particular case status, if the case status of a case instance is changed to that case status by a (e.g., last) task of a (previous) checklist, the execution of that checklist may be automatically initiated when that case status is set for that case instance (e.g., when a last task of a previous checklist is completed).

According to embodiments, therefore, a lifecycle comprises a set of linked (or unlinked) phases comprising an independent checklist for each phase of the lifecycle. Thus, there can be multiple phases of the lifecycle that may be concurrently independently executing, (e.g., where the checklists for those phases may be independently executing). Such an implementation allows for simple updating of the lifecycle of a case type that provide for dynamic updating to the lifecycle process and management of case instances that have already be instantiated and whose lifecycle is already in progress.

Specifically, in embodiments, even after one or more phases of a lifecycle for a case model (e.g., case type) has been defined, other processes for one or more additional phases of a lifecycle definition can be received. Again, in certain cases, the process may be defined by a user through an interface provided by the case management system. These additional phases may be associated with their own case status (e.g., different from the case statuses associated with previously defined phases). Checklists for these additional phases may be generated from the defined processes, where the checklist includes a list of ordered tasks corresponding to the defined process, where those tasks may be automated or manual. The checklist for a phase may be associated with an initiating event which will cause the automatic execution of the checklist. This initiating event may, for example, be the creation (or existence) of a case instance, or a particular case status being associated with a case instance. The phases of a lifecycle can be ordered, or sequenced, by associating the checklist with initiating events corresponding to other phases (e.g., previous phases). These additional phases, including their associated checklists, may be associated with the lifecycle definition of the case type such that these phases may be executed for case instances in association with the other phases of the lifecycle definition, including the execution in parallel of these additional phases with previously defined phases. Moreover, the case status of a case instance may be set based on each executing phase of the lifecycle such that the case status of a case instance may reflect the status of each executing phase of the lifecycle definition.

Furthermore, not only may future instances of that case type include the additionally defined phases but case instances that have already been instantiated and which lifecycles are already in progress may by dynamically updated such that the newly added phases may be executed in association with these cases instances (and their status updated to reflect the status of these newly added phases), even though these case instances may have been instantiated, and their lifecycles initiated, prior to the newly added phases being defined. In particular, according to one embodiment, such a checklist may be created with a special marker field such that the execution of the checklist will be automatically initiated for each existing case instance of the case type once the new phase is added to the lifecycle. In other embodiments, when a phase with a checklist is added to a lifecycle definition for a case model, each extant case instance of that case model may be evaluated to see if an initiating event for that newly added phase (e.g., checklist) has occurred in association with that case instance. If the initiating event for the new phase (e.g., checklist) has occurred, the checklist for that phase may be automatically executed, where the execution of that checklist for the new phase is independent of the execution of any executing checklist for any other (e.g., previously defined) phase of the lifecycle for that case instance. The checklist for the new phase can thus be executed regardless of the case status associated with the case instance.

The case status of that case instance may also be updated to reflect the execution status of this newly added phase, such that the case status for the case instance reflects not only the status of any currently executing (e.g., previously defined) phase of the lifecycle, but may also reflect the status of the execution of the newly added phase. Thus, in circumstances where the initiating event for the newly added phase (e.g., checklist) is the creation (or existence) of a case instance, or the phase is otherwise indicated for automatic execution, the new checklist may begin automatic execution at the point the new phase is added to the lifecycle of the case model and the case status automatically updated to reflect the additional execution of the new phase. The case status of the newly added phase can, for example, be appended or added to any existing case status associated with other executing phases of the lifecycle. Embodiments may thus dynamically update the lifecycle and the status of the lifecycle for existing case instance and also may utilize and maintain multiple lifecycle statuses at a single point in time.

It is important to note that the term checklist as used herein is different from the term checklist as it may have been utilized. Typically, electronic checklists are just independent lists that are not related to the lifecycle of a case. The items in a typical checklist may be completed out of order (even where maintain order may be important) and usually require manual involvement to maintain a completion indication with respect to items of a checklist.

In contrast, a checklist as used herein represents a process (or definition of a process) that may be used to manage the lifecycle of a case (e.g., a case instance). These checklists may be completely automated (e.g., the tasks may be automated) whereby the order of the execution of the tasks of the checklist are maintained, and thus not require any use involvement to maintain a completion status of the tasks of a checklist or to transition between the tasks of a checklist or between different checklists of different phases. These different checklists may become “visible” (e.g., excited) based on the lifecycle of the case instance (e.g., based on a case status of the case instance or an initiating event).

These, and other, aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions, or rearrangements may be made within the scope of the disclosure without departing from the spirit thereof, and the disclosure includes all such substitutions, modifications, additions, or rearrangements.

### BRIEF DESCRIPTION OF THE DRAWINGS

The drawings accompanying and forming part of this specification are included to depict certain aspects of the invention. A clearer impression of the invention, and of the components and operation of systems provided with the invention, will become more readily apparent by referring to the exemplary, and therefore non-limiting, embodiments illustrated in the drawings, wherein identical reference numerals designate the same components. Note that the features illustrated in the drawings are not necessarily drawn to scale.

FIG. 1 is a flow diagram of one embodiment of a method for case management.

FIG. 2 is a block diagram of one embodiment of a system for case management.

FIG. 3 is a block diagram of one embodiment of a system for case management.

FIG. 4 is a flow diagram of one embodiment of a method for case management.

FIGS. 5A and 5B are diagrammatic representations of an embodiment of a case management system and method.

FIG. 6A is a diagrammatic representation of an example of a lifecycle.

FIG. 6B is a diagrammatic representation of an example of a checklist.

FIG. 6C is a diagrammatic representation of an example of a checklist.

FIG. 7 is a flow diagram of one embodiment of a method for case management.

### DETAILED DESCRIPTION

The invention and the various features and advantageous details thereof are explained more fully with reference to the non-limiting embodiments that are illustrated in the accompanying drawings and detailed in the following description. Descriptions of well-known starting materials, processing techniques, components, and equipment are omitted so as not to unnecessarily obscure the invention in detail. It should be understood, however, that the detailed description and the specific examples, while indicating some embodiments of the invention, are given by way of illustration only and not by way of limitation. Various substitutions, modifications, additions, or rearrangements within the spirit or scope of the underlying inventive concept will become apparent to those skilled in the art from this disclosure.

Before describing embodiments in more detail, some context may prove useful. As discussed, in an enterprise environment, case management systems are used to automate the management of complex sets of documents or other content and associated processes comprising tasks that may be performed. Thus, these case management systems may be utilized with particular efficacy in situations in which the documents or other content that may need to be managed for respective particular instances of a case model may not be the same for each instance and the processing required or selected to be performed may not be the same for each instance.

In these case management systems, a case model typically describes a type of case, instances of which are to be managed by a case management system. A case may be thought of as a way of organizing documents (and, in some instances, the processes that are used to manage those documents). A case model is created at design time to create structure for the case (e.g., model for a set of folders). This structure is then created at runtime for an instance of the case when it is created. For example, the case model definition may include a hierarchical container model portion defining a hierarchical data model representing how case data is organized using a plurality of hierarchically related case nodes.

As opposed to very structured business process that defines a predetermined work flow that does not vary from instance to instance, using a case model one can model ad hoc actions and define responses thereto with workflows, enabling the processing of respective instances of a case model to be determined dynamically at runtime based, e.g., on events, context data, user input, dynamic evaluation of documents or other content, etc. As a result, each instance of a case model (e.g., the respective loan applications of different applicants or each individual employee) may follow its own course as determined at each step by processing (e.g., that may be defined in applicable portions of the case model).

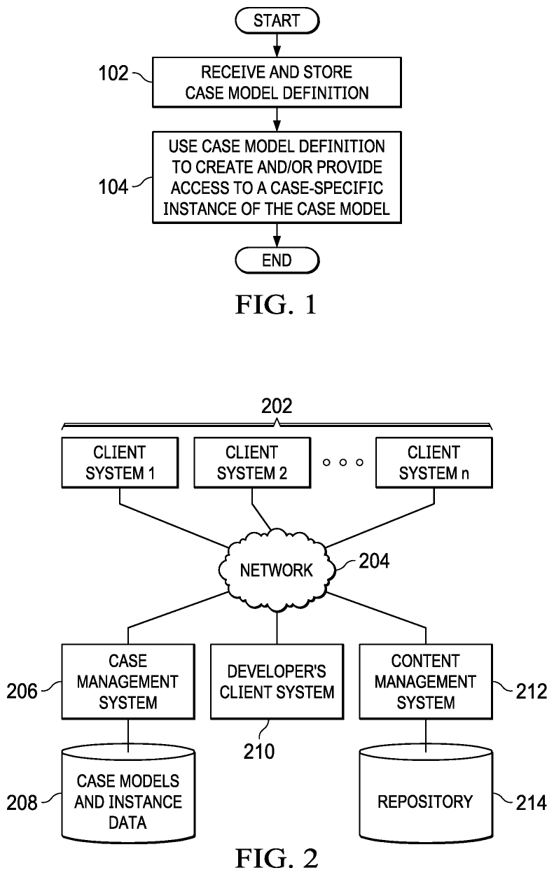

Moving then to FIG. 1, a flow chart illustrating an example embodiment of a process to perform case management is depicted. In the example shown, a case model definition is received and stored (STEP 102). The case model definition is used to create new instances based on the case model, sometimes referred to herein as “case instances” or “case management instances”, or to provide access to previously-created instances (STEP 104). For example, a case model may be defined and stored for an employee and an associated process and a loan application and associated processes. Case instances may be created based on the case model and each respective case instance used to manage a corresponding loan application, for example by different respective loan applicants.

Using a case model, one can model ad hoc actions with smaller processes, for example, as opposed to very structured process that defines an end-to-end workflow. In various embodiments, a case model comprises a hierarchical/nested container model (sometimes referred to herein as a “hierarchical data model”), and may in addition define case roles, case phases (states), or permissions. In some embodiments, permissions may be defined for each case node or level in the hierarchy, and may vary in some embodiments based at least in part on the respective phases (states) of a state machine defined for a case node.

In various embodiments, a case model may include a hierarchical or nested container model. This model represents how the data within a case is organized and what data is captured during runtime. Each node in the hierarchy is sometimes referred to herein as a “case node”. Case nodes at the lowest level of a case model hierarchy may be referred to as “case leaf nodes” or simply “leaf nodes”. “Case leaf nodes” in various embodiments may point to a specific business object or document type.

The term “case role” is used herein to refer to user roles that have been defined in a case model. In various embodiments, users may be assigned to case roles with respect to instances of a case model, and at each case node in the case model permissions may be designated by reference to one or more case roles. During runtime in some embodiments members may be added or removed from these roles at case node instances corresponding to respective instances of a type of case as defined in a case model.

In various embodiments, a case model as described herein may be created using a domain-specific or other development module or tool. For example, reusable elements, such sample case nodes typical of those used in the domain (e.g., documents, case roles, behaviors, etc. that may be associated with a an employee, loan application process, a new drug approval application, etc.), primitives usable to define a state machine or associated processing for respective case nodes, etc., may be provided. For example, an application programming interface (API) may be defined, or a visual or other case model development tool may be provided.

A case model definition may be embodied in an eXtensible Markup Language (XML) or other structured data file. A case management system/or platform is provided, which is configured (e.g., by software) to load a case model definition, parse the definition, and create an instance of the case model based on the definition. Instance-specific attributes or state information or other metadata may be stored in a case model instance data store (e.g., a database). At runtime, the case model definition file and the case model instance data for a given instance are used by the case management system to implement the case model instance, including by performing processing and managing case model instance associated content per the case model definition, in light of the current values of the case model instance data for that instance.

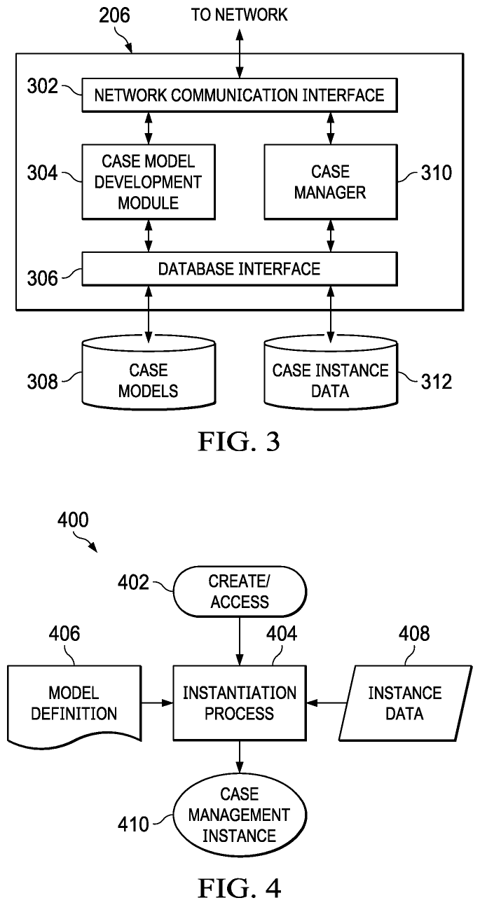

FIG. 2 is a block diagram illustrating an example embodiment of a case management system and environment. In the example shown, client systems 202 are connected via a network 204 (e.g., the Internet, a LAN, a WAN, a wired, cellular or other wireless network, etc.) to a case management system 206. In various embodiments, the case management system 206 may be configured to implement the process of FIG. 1. Case management system 206 uses case models stored in data storage 208 to provide case management services with respect to case management instances, the instance variable data values of which also are stored, in this example, in data storage 208. For example, one or more of clients 202 may connect via network 204 to case management system 206 to obtain access to case management services. For example, case management system 206 may expose a “case management system as a service” (e.g., as a web service) enable clients 202 to connect to case management system 206, create case management instances based on case models stored in data storage 208. The users of client system 202 may be prompted to provide data values or other user input to populate case management instances with metadata, user data, documents, etc., or such other user input as may be required to advance case instances through case management processing as defined in the case model.

In the example shown in FIG. 2, a case model developer system 210 (e.g., a client computer system) also can connect to case management system 206 via network 204. In some embodiments, a case model development user interface or service may be accessed and used to define a case model. For example, a visual or other developer tool may be presented to enable a developer using client system 210 to define a case model and cause the case model to be stored in data storage 208 and deployed by case management system 206. In some embodiments, deployment of a case model includes making the case model available to be used to create case management instances based on the model, and to use the case model to perform with respect to each such instance the case management processing as defined in the case model.

In various embodiments, a case model may indicate one or more content objects to be associated with respective instances of a case model. The case model may include metadata and associated behaviors to enable instance-specific content objects (e.g., documents) to be associated with case leaf nodes of a case instance. In the example shown in FIG. 2, content objects may be accessed via a content management system 212 configured to manage content objects stored in an associated content repository 214. In various embodiments, case management system 206 may be configured to use instance variables associated with a given case instance and metadata or behaviors defined in an associated case model to interact programmatically with content management system 212 to obtain or manage documents or other content objects associated with a case instance. In some embodiments, case management system 206 may be configured, e.g., via the case model, to invoke services or other functionality of content management system 212 with respect to such documents or other content objects.

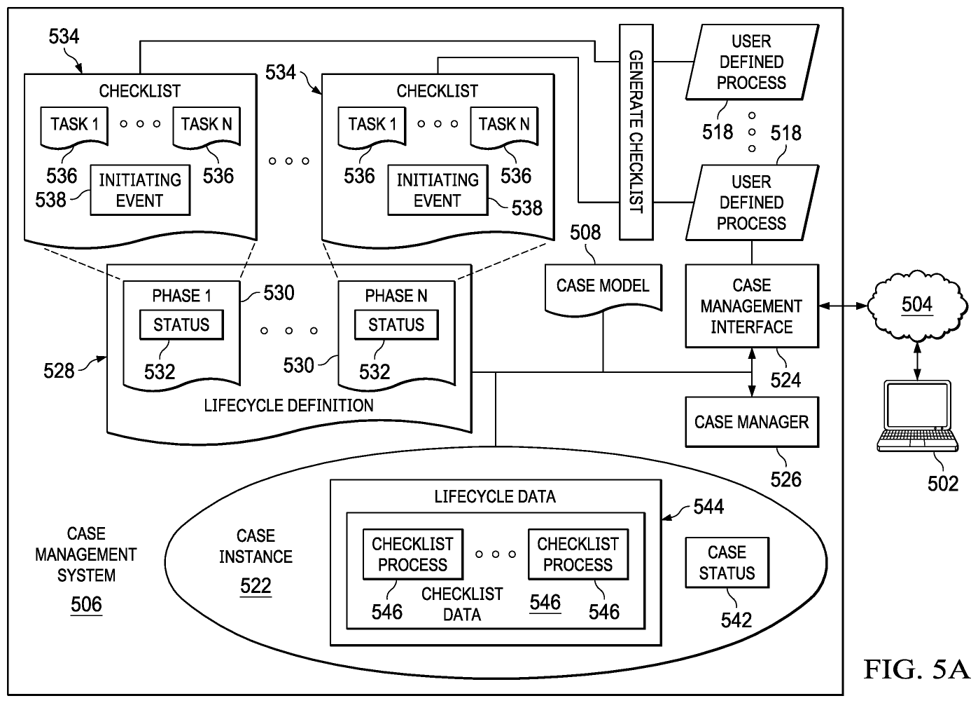

FIG. 3 is a block diagram illustrating an example embodiment of a case management system. In some embodiments, the case management system of FIG. 3 corresponds to case management system 206 of FIG. 2. In the example shown, case management system 206 includes a network communication interface 302, such as a wireless or other network interface card, to provide network connectivity, e.g., to network 204 of FIG. 2. A case model development module 304 is accessible to developers via network communication interface 302 and may be used to create or modify case model definitions. In some embodiments, a visual or other user interface is provided, via network communication interface 302, to enable case models to be created or modified. For example, a developer may use a browser to access the developer user interface in some embodiments. Case model definitions are stored by case model development module 304 by using a backend database (or other data storage) interface 306 to store the case model(s) in case model store 308.

Referring further to FIG. 3, the case management system 206 includes a case management module 310. In various embodiments, case management module 310 includes functionality to enable users, e.g., users of client systems 202 of FIG. 2, to create or use case management instances based on case models stored in case model store 308. Case management module 310, for example, may expose a web or other interface to remote users and may receive via said interface a request to create or access a case instance. Case management module 310 uses database interface 306 to obtain an associated case model definition from case model store 308, to use the case model to instantiate case instances. Instance variables are stored by case management module 310 in case instance data store 312.

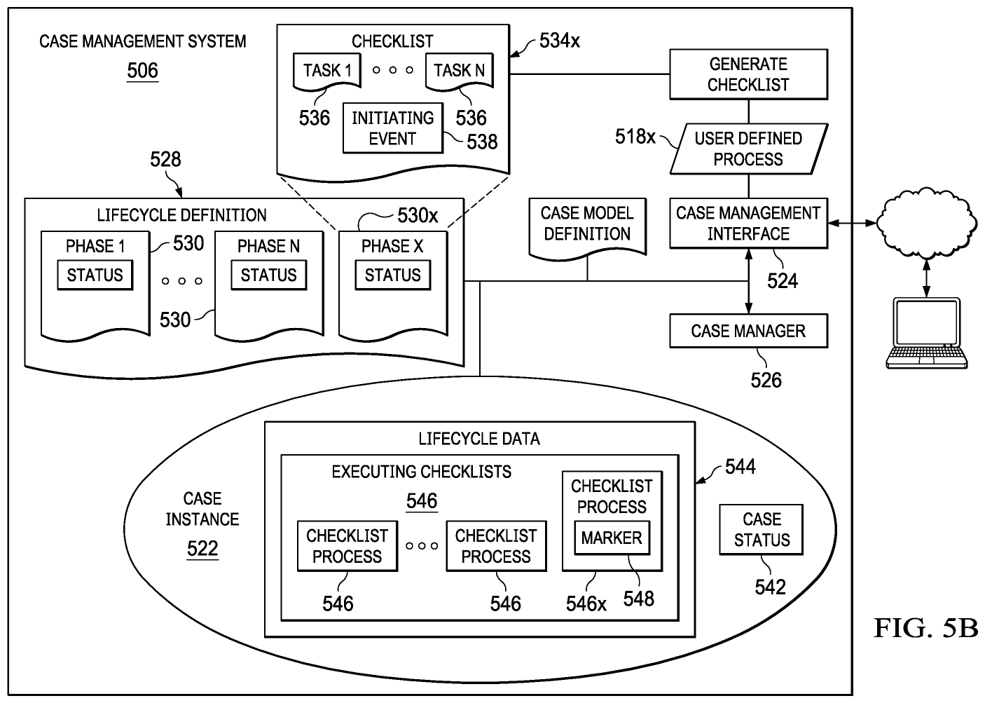

FIG. 4 is a diagram illustrating an example embodiment of a process and system to create or provide access to case management instances. In some embodiments, the process of FIG. 4 may be implemented by a case management system or a component thereof, such as case manager 310 of FIG. 3. In the example shown, case management system 400 receives a request 402 to create or access a case management instance and invokes instantiation process 404. Instantiation process 404 uses a case model definition 406 associated with the request, e.g., a case model indicated explicitly or otherwise associated with data comprising the request 402, and case management instance data 408 associated with the case management instance, to instantiate and provide access to a case management instance 410.

In various embodiments, a case model definition such as model definition 406 may include an XML file or other structured data, which the case management system is configured to parse and use to construct case instances based on the case model. For example, the hierarchical data structure may be defined, along with metadata and associated behaviors for each case node. A case management instance, such as case management instance 410, may include an in memory instance of a data structure defined in case model definition 406, which is used to store instance variables, such as instance data 408 in this example.

As can be seen then, using a case model one can model ad hoc actions and define responses thereto, enabling the processing of respective instances of a case model to be determined dynamically at runtime based, e.g., on events, context data, user input, dynamic evaluation of documents or other content, etc. As a result, each instance of a case model (e.g., the respective loan applications of different applicants or each individual employee) may follow its own course as determined at each step by processing (e.g., that may be defined in applicable portions of the case model).

Specifically, in certain cases, the processes that may be accomplished with respect to a type of case is defined by a lifecycle. The lifecycle may be thought of as a set of phases representing processes that may be performed in association with an instance of the case. These phases may have an ordered progression and a status associated with each phase. Thus, such a lifecycle may be defined for a type of case and may be included, for example, in the case model definition for a type of case. Accordingly, the lifecycle of a case instance at runtime may be managed by a corresponding lifecycle process created when a new case instance is created based on the lifecycle process defined at design time. Each case instance can thus be at a different (or same) phase of the lifecycle process. Each case instance can thus maintain a case status indicating the status of the phase that the case instance is in.

However, the use of these lifecycle processes is not without problems. In certain implementations, a user may be manually required to navigate between the different phases of a life cycle for a case instance, manually moving the case instance between the various phases and setting the case status on the case instance based on the phase of the lifecycle. Moreover the use of a defined lifecycle is problematic for other reasons. Typically, once the lifecycle for a case is defined it becomes difficult to implement changes or alterations to that lifecycle or, in general, to add additional processes to that type of case. Suppose, for example, that a user wishes to add a process to a case instance. If it is unrelated to the other phases of the lifecycle it may be desired to track the status of each case instance with respect to that process independently to the existing phases of the lifecycle. This tracking is difficult, as there may be only a single case status for the case instance, or may require the user to independently set two case status. Additionally, even if such a new phase is added to the existing lifecycle at a particular point in the lifecycle (e.g., between two sitting phases of the lifecycle), any case instance has progressed passed that point in the lifecycle will not go through that phase, or will require manual user intervention and involvement to reset that case instance to the point where it will undergo that newly added phase.

What is desired, therefore, are systems and method for case management that provide a more effective way of managing the lifecycle of case instances, including that ability to automatically move case instances between phase of a lifecycle and to introduce new processes to the lifecycle where those phases may be independently performed and have their status independently tracked with respect to each case instance.

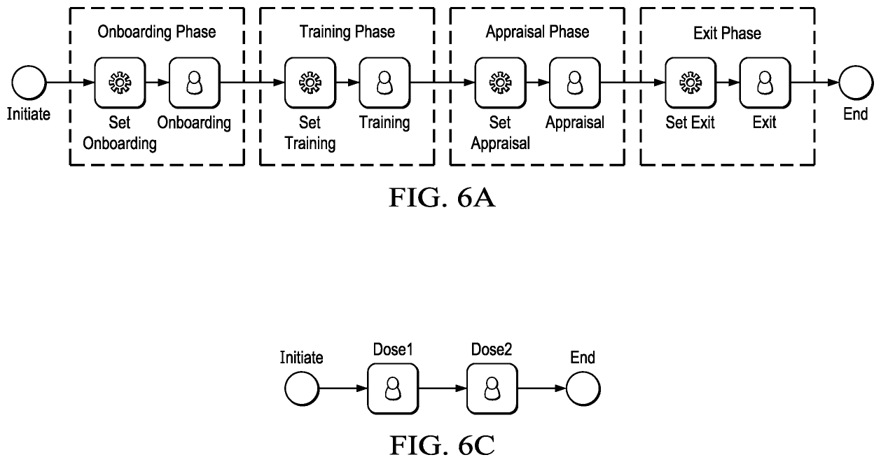

To address those desires, among others, attention is now directed to embodiments of the case management systems and methods disclosed herein that utilize checklists to manage the lifecycle of the cases of the case management system. FIG. 5A depicts one embodiment of just such a case management system. In the example shown, client systems 502 are connected via a network 504 (e.g., the Internet, a LAN, a WAN, a wired, cellular or other wireless network, etc.) to a case management system 506. Case management system 506 uses case models (e.g., a definition of a case model) 508 to provide case management services with respect to case instances 522 that include the stored instance variable data values that case instance. For example, one or more of clients 502 may connect via network 504 to case management system 506 to obtain access to case management services.

For example, case management system 506 may expose a case management interface 524 (e.g., as a web service, a browser based interface, a graphical user interface, etc.) adapted to allow users at clients 502 to interact with case management system 506 to define case models 508 or associated data and to create or interact with case management instances 522. The case management interface 524 may interface with case manager 526 to enable users at client system 502 to define case models 508 or create or use case instances 522 based on case models 508. Case manager 526 may thus, in response to a request received through the case management interface 524, obtain an associated case model 508 to use the case model 508 to instantiate case instances 522. Instance variables are stored, accessed, and manipulated in the case instance 522 by the case manager 526.

In certain embodiments, a case model 508 may include, or be associated with, a lifecycle definition 528 (also referred to just as a lifecycle) for a type of case. The lifecycle 528 may include a set of phases 530. The phases 530 may, for example, be defined by a user using case management interface 524. These phases 530 of a lifecycle 528 may, for example, be independent and each associated with a status 532 (e.g., an indicator of that phase 530).

A process 518 can be defined for each of the phases 530 (e.g., a user may define a process for a phase using the case management interface 524 or the like). For example, a user can use case management interface 524 to define a process 518 using natural language or a combination of natural language with another method of defining a process (e.g., a library of steps or computer readable code, etc.). Based on the process 518 for a phase 530, a checklist 534 can be created for that phase 530, where the checklist 534 includes a list of ordered tasks 536, where those tasks 536 may be automated or manual. In various embodiments, a checklist 534 for a process may include an XML file or other structured data, which the case management system 506 is configured to parse and use to execute these checklist for case instances 522. An example of such a structured data file for a checklist 534 is given in the Appendix.

The checklist 534 for a phase 530 may be associated with an initiating event 538 which will cause the (e.g., automatic) execution of the checklist 534. These initiating events 538 may be associated with a case status 542 of a case instance. The phases 530 of a lifecycle 528 can be ordered, or sequenced, by associating the checklist 534 with initiating events 538 corresponding to other phases 530 (e.g., previous phases). For example, an initiating event 538 of a first phase 530 (or first task 536 of a first phase 530) of a lifecycle 528 may be associated with the creation of a case instance 522 or a particular status 542 being associated with a case instance 522, an initiating event 538 of one checklist 534 may be associated with a task 536 (e.g., a last task 536) of the checklist 534 of a previous phase 530, or a last task 536 of a checklist 534 of a phase 530 may be associated with subsequent phase 530 of the lifecycle 528.

In this manner, each phase 530 of the lifecycle 528 may be associated with an independent process (e.g., a checklist 534) that includes a set of ordered tasks 536 and an initiating event 538. Thus, when a case instance 522 of a case model 508 is created a lifecycle 528 corresponding to that case instance 522 may be initiated by automatically initiating the execution of the checklist for the first phase of the lifecycle (e.g., any phase or checklist which has an initiating event defined as the creation of a case instance). In other words, the creation of a case instance may be allowed to trigger the lifecycle 528 for that case instance 522. Lifecycle data 544 for the lifecycle 528 for that case instance 522 may be stored for that case instance 522, where that lifecycle data 544 may include executing checklist data 546 on each executing checklist 534 (e.g., currently executing or past executing, etc.) associated with the lifecycle 528 of that case instance 522, including for example, which tasks 526 of that checklist have been completed and which task 536 of that checklist 534 have not been completed.

Additionally, a case status 542 of the case instance 522 may be set to indicate the case status 532 associated with the (e.g., currently) executing phase 530 of the lifecycle 528. In some embodiments, when each of the set of ordered tasks 536 of the checklist 534 of an executing phase 530 is completed for the case instance 522 a completed indicator for that task 536 may be stored in the checklist data 546 for that checklist 534 in association with the case instance 522, wherein a (e.g., subsequent) task 536 of that checklist 534 may not be indicated as completed until the previous task 536 of the set of ordered tasks 536 of the checklist 534 is indicated as completed. In this way the ordered execution of the tasks 536 of a checklist 534 may be ensured or verified (e.g., by case manager 526).

When the last task 536 of the ordered set of tasks 536 of the checklist 534 is completed, if the last task 536 of the checklist 534 is associated with any subsequent phase 530, the execution of the checklist 534 associated with that subsequent phase 530 may be automatically initiated for that case instance 522, and the case status 542 of the case instance 522 updated to indicate the case status 532 (e.g., of the phase 530) associated with that subsequent checklist 534. For example, if an initiating event 538 of a checklist 534 for a phase 530 is a particular case status 532, if the case status 542 of the case instance 522 is changed to that case status 532 by a (e.g., last) task 536 of a (previous) checklist 534, the execution of that checklist 534 may be automatically initiated when that case status 542 is set for that case instance 522 (e.g., when a last task 536 of a previous checklist 534 is completed).

According to embodiments, therefore, a lifecycle 528 comprises a set of linked (or unlinked) phases 530 comprising an independent checklist 534 for each phase 530 of the lifecycle 528. Thus, there can be multiple phases 530 of the lifecycle 528 that may be concurrently and independently executing, (e.g., where the checklists 534 for those phases may be independently executing). Such an implementation allows for simple updating of the lifecycle (e.g., definition) 528 of a case type that provide for dynamic updating to the lifecycle process and management of case instances 522 that have already been instantiated and whose lifecycle 528 is already in progress.

To illustrate this, attention is directed to FIG. 5B which depicts an a case management system that is adapted for dynamic updating to a lifecycle. Specifically, in embodiments, even after one or more phases 530 of a lifecycle 528 for a case model 508 (e.g., case type) has been defined, other processes for one or more additional phases 530x of a lifecycle definition can be received. Again, in certain cases, the process 518x may be defined by a user through an interface 524 provided by the case management system 506. These additional phases 530x may be associated with their own case status 532x (e.g., different from the case statuses 532 associated with previously defined phases). A checklist 534x for this additional phase 530x may be generated from the defined processes 518x, where the checklist 534x includes a list of ordered tasks 536 corresponding to the defined process 518x, where those tasks 536 may be automated or manual. This checklist 543x for the phase 530x may also be associated with an initiating event 528 which will cause the automatic execution of the checklist 536. This initiating event may, for example, be the creation (or existence) of a case instance 522, or a particular case status 542 being associated with a case instance 522. The phases 530 of a lifecycle 528 can be ordered, or sequenced, by associating the checklists 524 with initiating events corresponding to other phases 530 (e.g., previous or subsequent phases). These additional phases 530x, including their associated checklists 534x, may be associated with the lifecycle definition 528 of the case type (e.g., associated with case model 508) such that these phases 530x may be executed for case instances 522 in association with the other phases 530 of the lifecycle definition 528, including the execution in parallel of these additional phases 530x with previously defined phases. Moreover, the case status 542 of a case instance 522 may be set based on each executing phase 530 of the lifecycle 528 such that the case status 542 of a case instance 522 may reflect the status 530 of each executing phase 530 of the lifecycle 528.

Furthermore, not only may future instances of that case model 508 include the additionally defined phases 530x but case instances 522 that have already been instantiated and which lifecycles 528 are already in progress may by dynamically updated such that the newly added phases 530x may be executed in association with these cases instances 522 (and their status 542 updated to reflect the status of these newly added phases 530x), even though these case instances 522 may have been instantiated, and their lifecycles 528 initiated, prior to the newly added phases 530x being defined. In particular, according to one embodiment, such a checklist process 546x for checklist 524x may be created with a special marker field 548 such that the execution of the checklist 524x will be automatically initiated for each existing case instance 522 of the case model 508 once the new phase 530x is added to the lifecycle 528.

In other embodiments, when a phase 530x with a checklist 534x is added to a lifecycle definition 528 for a case model 508, each extant case instance 522 of that case model 508 may be evaluated to see if an initiating event for that newly added phase 530x (e.g., checklist 534x) has occurred in association with that case instance 522. If the initiating event 538 for the new phase 530x (e.g., checklist 534x) has occurred, the checklist 524x for that phase 530x may be automatically executed, where the execution of that checklist 534x for the new phase 530x is independent of the execution of any executing checklist 546 for any other (e.g., previously defined) phase 530 of the lifecycle 528 for that case instance 522. The checklist 534x for the new phase can thus be executed 546x regardless of the case status 542 associated with the case instance 522.

The case status 542 of that case instance may also be updated to reflect the execution status of this newly added phase 530x, such that the case status 542 for the case instance 522 reflects not only the status 532 of any currently executing (e.g., previously defined) phase 530 of the lifecycle 528, but may also reflect the status 532x of the execution of the newly added phase 530x. Thus, in circumstances where the initiating event 528 for the newly added phase 530x (e.g., checklist 534x) is the creation (or existence) of a case instance 522, or the phase 530x is otherwise indicated for automatic execution (e.g., using a special marker or the lie recognizable by case manager 526), the new checklist 534x (e.g., executing checklist process 546x) may begin automatic execution substantially at the point the new phase 530x is added to the lifecycle (definition) 528 of the case model 508 and the case status 542 of the case instance 522 automatically updated to reflect the additional execution of the new phase 530x. The case status 532x of the newly added phase 530x can, for example, be appended or added to any existing case status 542 associated with other executing phases 530 of the lifecycle 528. Embodiments may thus dynamically update the lifecycle and the status of the lifecycle for an existing case instance 522 and also may utilize and maintain multiple lifecycle statuses 542 at a single point in time.

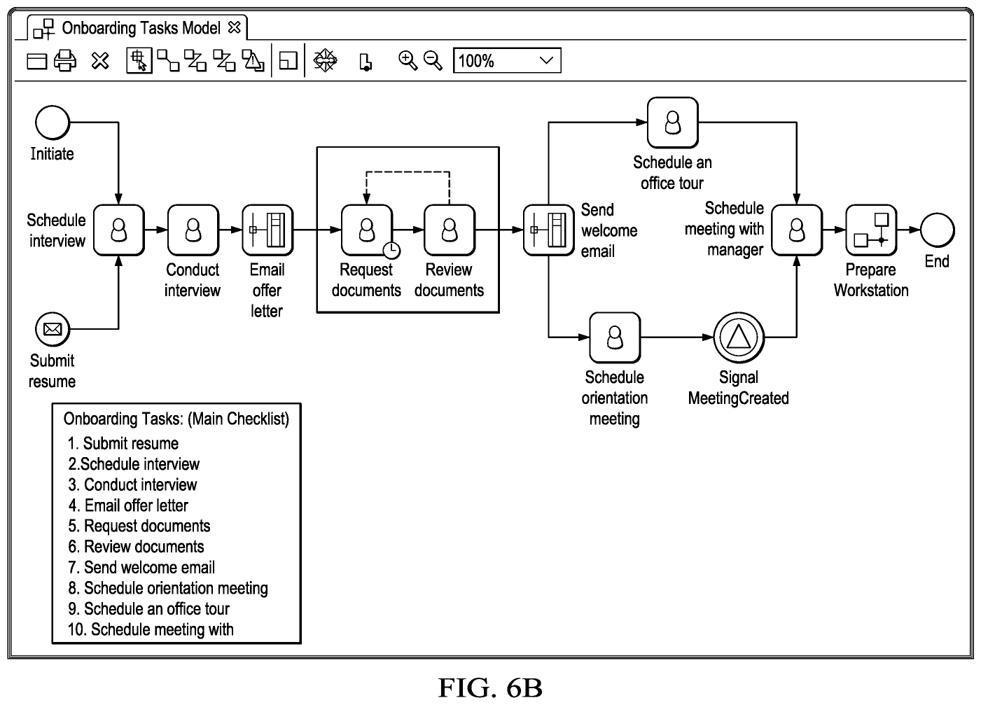

It may be useful to go over an example of a lifecycle and the use of a checklist in the management a lifecycle of a case instance. Looking then at FIGS. 6A and 6B, in FIG. 6A a graphical depiction of an example lifecycle that may be defined for an “employee” case type is depicted, while in FIG. 6B depicts an example process and associated checklist of ordered tasks that may be defined for the “onboarding” phase of the lifecycle depicted in FIG. 6A. The Appendix includes an example structured definition for such a checklist. Thus, for example lifecycle for an “employee” case there may be three phases, with three associated checklist defined for the lifecycle: “onboarding”, “training” and “exit”. When a new case instance is created the case status of the new case instance will be set to onboarding as it is the first stage of the lifecycle.

Events for each checklist may be created for the tasks or the phases, where the events are adapted to allow the checklist processes to operate based on the case status for a case instance. Thus, for example, the onboarding checklist process starts running when a new employee case is created. When a checklist task is completed that task may be automatically marked as complete. For example, an executing instance of a checklist may have a set of tasks items representing each task, with an associated property. The property for a completed task marked as “completed” in the checklist data for the case instance.

When the last task of the checklist process is completed, the case status may be update to the status for the next phase of the lifecycle. Here last task in the onboarding checklist process will set the case status for a case instance as “training” (for the training phase) when completed. When the case status for a case instance changes the next checklist (e.g., here the “training” checklist) is triggered. Thus, checklists for phases of a lifecycle may be run automatically and case lifecycle is changed based on the completion of checklists for phases.

As can be seen then, a lifecycle process may be started when a new case instance is created. Each case instance may be at a different phase of the life cycle. For instance in this example, every “employee” case instance can be at a different phase of the lifecycle. Employee A may be at onboarding while Employee B can be at Exit.

Now suppose that it is desired to implement a new phase or checklist with respect to each “employee”. For example, an enterprise may desire to vaccinate its employees and also needs to track the status of vaccination. In this example, a new vaccination checklist process for a new “vaccination” phase will be created as depicted in FIG. 6C.

As the “vaccination” phase has to be added as a new phase of the lifecycle it may be desirable to execute this checklist regardless of the phase of the lifecycle (e.g., onboarding, training, exit) that is currently executing for each employee.

Embodiments may thus allow the new vaccination checklist to start executing once deployed. There may be no need for an event from another checklist to trigger the vaccination process. Moreover, in this example, the status associated with the vaccination checklist process will be appended to the existing case status for each employee instance. This way an employee whose status is “onboarding” can also have a case status reflecting “vaccination”. Similarly, an employee who whose status is “training” can also have a case status reflecting “vaccination”.

This vaccination checklist process can thus go on in parallel with other checklist processes like onboarding, training, exit, etc. These other checklist process can also set the case status of a case instance based on their status. For example, when a training checklist completes and the appraisal checklist starts the case status may change, for example, from “Training, Under Vaccination” to “Appraisal, Under Vaccination”. Thus, embodiments make it possible to dynamically update the status of a lifecycle for a case instance and also to have multiple lifecycle relates statuses at a single point in time.

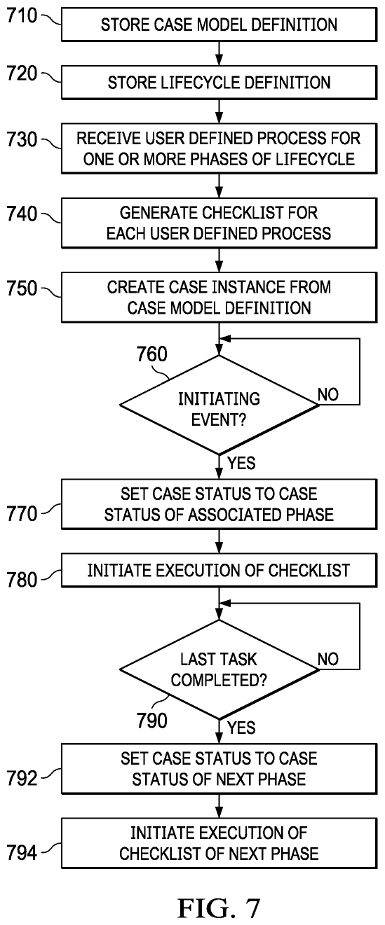

Moving on to FIG. 7, one embodiment of a method for managing the lifecycle of case instances using a checklist is depicted. Such a method may be implemented, for example, by embodiments of a case management system as disclosed herein. Initially, a case model definition (i.e., a case model) can be stored (STEP 710) by the case management system. This case model definition may be received or initiated by a user using an interface of the case management system. The case model definition can include a hierarchical container model portion defining a hierarchical data model representing how case data is organized and comprising a plurality of hierarchically related case nodes.

A user can also utilize the interface of the case management system to define a lifecycle. Thus, a lifecycle definition for the case model definition can be stored (STEP 720), wherein the lifecycle comprises a set of phases and a different status associated with each of the first set phases. The user may also be utilized the interface of a case management system to define processed for each of these phases. These user defined process for these phases can then be received (STEP 730). A checklist can be generated for each defined process to generate a checklist for an associated phase of the lifecycle definition (STEP 740). Such a checklist may include a set of ordered tasks corresponding to the user defined process for the phase and an initiating event. A last task of the set of ordered tasks of the checklist may also be associated with another (e.g., subsequent) phase of the lifecycle definition.

At some point, a case instance may be created from the case model definition (STEP 750), wherein the case instance has a case status reflecting the current status of the case (e.g., the one or more currently executing phases or checklists of the case instance. When an initiating event for a checklist occurs, a lifecycle for the case instance may be created and associated with the case instance. Based on the occurrence of the initiating event in association with the case instance (Y branch of STEP 760), the case status of the case instance may be set to indicate the case status associated with the phase of the lifecycle (e.g., associated with the initiating event) (STEP 770). The execution of the associated checklist of the phase of the lifecycle definition with respect to that case instance can then be initiated (STEP 780). Based on the completion of the last task of the set of ordered tasks of the checklist (Y branch of STEP 790), the case status of the case instance may be set to indicate the case status associated with a subsequent phase of the lifecycle definition (STEP 792), and the execution of the checklist of the subsequent phase of the lifecycle definition initiated with respect to the case instance (STEP 794).

Although the invention has been described with respect to specific embodiments thereof, these embodiments are merely illustrative, and not restrictive of the invention. Rather, the description is intended to describe illustrative embodiments, features, and functions in order to provide a person of ordinary skill in the art context to understand the invention without limiting the invention to any particularly described embodiment, feature, or function, including any such embodiment feature or function described in the Abstract or Summary. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Those skilled in the relevant art will appreciate that the invention can be implemented or practiced with other computer system configurations, including without limitation multi-processor systems, network devices, mini-computers, mainframe computers, data processors, and the like. The invention can be embodied in a computer or data processor that is specifically programmed, configured, or constructed to perform the functions described in detail herein. The invention can also be employed in distributed computing environments, where tasks or modules are performed by remote processing devices, which are linked through a communications network such as a LAN, WAN, or the Internet. In a distributed computing environment, program modules or subroutines may be located in both local and remote memory storage devices. These program modules or subroutines may, for example, be stored or distributed on computer-readable media, including magnetic and optically readable and removable computer discs, stored as firmware in chips, as well as distributed electronically over the Internet or over other networks (including wireless networks). Example chips may include Electrically Erasable Programmable Read-Only Memory (EEPROM) chips. Embodiments discussed herein can be implemented in suitable instructions that may reside on a non-transitory computer-readable medium, hardware circuitry or the like, or any combination and that may be translatable by one or more server machines.

ROM, RAM, and HD are computer memories for storing computer-executable instructions executable by the CPU or capable of being compiled or interpreted to be executable by the CPU. Suitable computer-executable instructions may reside on a computer-readable medium (e.g., ROM, RAM, or HD), hardware circuitry or the like, or any combination thereof. Within this disclosure, the term “computer-readable medium” is not limited to ROM, RAM, and HD and can include any type of data storage medium that can be read by a processor. For example, a computer-readable medium may refer to a data cartridge, a data backup magnetic tape, a floppy diskette, a flash memory drive, an optical data storage drive, a CD-ROM, ROM, RAM, HD, or the like. The processes described herein may be implemented in suitable computer-executable instructions that may reside on a computer-readable medium (for example, a disk, CD-ROM, a memory, etc.). Alternatively, the computer-executable instructions may be stored as software code components on a direct access storage device array, magnetic tape, floppy diskette, optical storage device, or other appropriate computer-readable medium or storage device.

Reference throughout this specification to “one embodiment”, “an embodiment”, or “a specific embodiment” or similar terminology means that a particular feature, structure, or characteristic described in connection with the embodiment is included in at least one embodiment and may not necessarily be present in all embodiments. Thus, respective appearances of the phrases “in one embodiment”, “in an embodiment”, or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

In the description herein, numerous specific details are provided, such as examples of components or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Any suitable programming language can be used to implement the routines, methods or programs of embodiments of the invention described herein, including C, C++, Java, JavaScript, HTML, or any other programming or scripting code, etc. Other software/hardware/network architectures may be used. For example, the functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

Different programming techniques can be employed such as procedural or object oriented. Any particular routine can execute on a single computer processing device or multiple computer processing devices, a single computer processor or multiple computer processors. Data may be stored in a single storage medium or distributed through multiple storage mediums, and may reside in a single database or multiple databases (or other data storage techniques). Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps, and operations described herein can be performed in hardware, software, firmware, or any combination thereof.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways or methods to implement the invention.

It is also within the spirit and scope of the invention to implement in software programming or code any of the steps, operations, methods, routines or portions thereof described herein, where such software programming or code can be stored in a computer-readable medium and can be operated on by a processor to permit a computer to perform any of the steps, operations, methods, routines or portions thereof described herein. In general, the functions of the invention can be achieved by, for example, distributed, or networked systems, components, and circuits. In another example, communication or transfer (or otherwise moving from one place to another) of data may be wired, wireless, or by any other means.

A “computer-readable medium” may be any medium that can contain, store, communicate, propagate, or transport the program for use by or in connection with the instruction execution system, apparatus, system, or device. The computer-readable medium can be, by way of example only but not by limitation, an electronic, magnetic, optical, electromagnetic, infrared, or semiconductor system, apparatus, system, device, propagation medium, or computer memory. Such computer-readable medium shall generally be machine readable and include software programming or code that can be human readable (e.g., source code) or machine readable (e.g., object code). Examples of non-transitory computer-readable media can include random access memories, read-only memories, hard drives, data cartridges, magnetic tapes, floppy diskettes, flash memory drives, optical data storage devices, compact-disc read-only memories, and other appropriate computer memories and data storage devices. In an illustrative embodiment, some or all of the software components may reside on a single server computer or on any combination of separate server computers. As one skilled in the art can appreciate, a computer program product implementing an embodiment disclosed herein may comprise one or more non-transitory computer-readable media storing computer instructions translatable by one or more processors in a computing environment.

It will also be appreciated that one or more of the elements depicted in the drawings/figures can be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited to only those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, including the claims that follow, a term preceded by “a” or “an” (and “the” when antecedent basis is “a” or “an”) includes both singular and plural of such term, unless clearly indicated within the claim otherwise (i.e., that the reference “a” or “an” clearly indicates only the singular or only the plural). Also, as used in the description herein and throughout the claims that follow, the meaning of “in” includes “in” and “on” unless the context clearly dictates otherwise. The scope of the present disclosure should be determined by the following claims and their legal equivalents.

What is claimed is:

1. A case management system comprising:
a processor;
a non-transitory computer readable medium, comprising instructions for:
storing a case model definition, the case model definition comprising a hierarchical container model portion, the hierarchical container model portion defining a hierarchical data model, the hierarchical data model representing how case data is organized and comprising a plurality of hierarchically related case nodes;
storing a first lifecycle definition for a first lifecycle for the case model definition, wherein the first lifecycle comprises a first set of phases and a different first case status associated with each of the first set phases;
receiving a first user defined process for a first phase of the first lifecycle definition;
receiving a second user defined process for a second phase of the first lifecycle definition;
generating a first checklist for the first phase of the first lifecycle definition, where the first checklist comprises a first set of ordered tasks corresponding to the first user defined process for the first phase and a first initiating event, and wherein a last task of the first set of ordered tasks of the first checklist is associated with the second phase of the first lifecycle definition;
generating a second checklist for the second phase of the first lifecycle definition, where the second checklist comprises a second set of ordered tasks corresponding to the second user defined process for the second phase and a second initiating event associated with at least one task of the first set of ordered tasks;
creating a first case instance from the case model definition, the first case instance having a first case status;
in response to creation of the first case instance, initiating a first lifecycle of the first lifecycle definition for the first case instance, wherein the first lifecycle is associated with the first case instance;
based on the occurrence of the first initiating event in association with the first case instance, setting the first case status of the first case instance to indicate the first case status associated with the first phase of the first lifecycle definition and automatically initiating the execution of the first checklist of the first phase of the first lifecycle definition with respect to the first case instance;
based on the completion of the last task of the first set of ordered tasks of the first checklist, setting the first case status of the first case instance to indicate the first case status associated with the second phase of the first lifecycle definition; and
in response to the completion of the last task of the first set of ordered tasks, automatically initiating the execution of the second checklist of the second phase of the first lifecycle definition with respect to the first case instance.

2. The case management system of claim 1, wherein the tasks are automated or manual tasks.

3. The case management system of claim 1, wherein each of the first set of ordered tasks is completed, storing a completed indicator for that task in association with the first case instance, wherein the task may not be indicated as completed until the previous task of the first set of ordered tasks is indicated as completed.

4. The case management system of claim 1, wherein the first user define process and the second user defined process are defined in a natural language.

5. The case management system of claim 1, wherein the instructions are further for:
receiving a third user defined process for a third phase of the first lifecycle definition, the third phase associated with a second case status;
generating a third checklist for the third phase of the first lifecycle definition, where the third checklist comprises a third set of ordered tasks corresponding to the third user defined process for the third phase of the first lifecycle definition and a third initiating event;
based on the third initiating event association with the third checklist occurring in association with the first case instance, setting the first case status of the first case instance to indicate the second case status associated with the third phase of the first lifecycle definition in addition to the indication of the first case status association with the first lifecycle definition, and automatically initiating the independent execution of the third checklist of the third phase of the second lifecycle definition with respect to the first case instance.

6. The case management system of claim 5, wherein the execution of the third checklist for the first case instance is initiated after the initiation of the first lifecycle for the first case instance.

7. The case management system of claim 6, wherein the third checklist executes regardless of the first case status associated with the first case instance.

8. A method, comprising:
storing a case model definition, the case model definition comprising:
a hierarchical container model portion, the hierarchical container model portion defining a hierarchical data model, the hierarchical data model representing how case data is organized and comprising a plurality of hierarchically related case nodes;
storing a first lifecycle definition for a first lifecycle for the case model definition, wherein the first lifecycle comprises a first set of phases and a different first case status associated with each of the first set phases;
receiving a first user defined process for a first phase of the first lifecycle definition;
receiving a second user defined process for a second phase of the first lifecycle definition;
generating a first checklist for the first phase of the first lifecycle definition, where the first checklist comprises a first set of ordered tasks corresponding to the first user defined process for the first phase and a first initiating event, and wherein a last task of the first set of ordered tasks of the first checklist is associated with the second phase of the first lifecycle definition;
generating a second checklist for the second phase of the first lifecycle definition, where the second checklist comprises a second set of ordered tasks corresponding to the second user defined process for the second phase and a second initiating event associated with at least one task of the first set of ordered tasks;
creating a first case instance from the case model definition, the first case instance having a first case status;
in response to creation of the first case instance, initiating a first lifecycle of the first lifecycle definition for the first case instance, wherein the first lifecycle is associated with the first case instance;
based on the occurrence of the first initiating event in association with the first case instance, setting the first case status of the first case instance to indicate the first case status associated with the first phase of the first lifecycle definition and automatically initiating the execution of the first checklist of the first phase of the first lifecycle definition with respect to the first case instance;
based on the completion of the last task of the first set of ordered tasks of the first checklist, setting the first case status of the first case instance to indicate the first case status associated with the second phase of the first lifecycle definition; and
in response to the completion of the last task of the first set of ordered tasks, automatically initiating the execution of the second checklist of the second phase of the first lifecycle definition with respect to the first case instance.

9. The method of claim 8, wherein the tasks are automated or manual tasks.

10. The method of claim 8, wherein each of the first set of ordered tasks is completed, storing a completed indicator for that task in association with the first case instance, wherein the task may not be indicated as completed until the previous task of the first set of ordered tasks is indicated as completed.

11. The method of claim 8, wherein the first user define process and the second user defined process are defined in a natural language.

12. The method of claim 8, further comprising:
receiving a third user defined process for a third phase of the first lifecycle definition, the third phase associated with a second case status;
generating a third checklist for the third phase of the first lifecycle definition, where the third checklist comprises a third set of ordered tasks corresponding to the third user defined process for the third phase of the first lifecycle definition and a third initiating event;
based on the third initiating event association with the third checklist occurring in association with the first case instance, setting the first case status of the first case instance to indicate the second case status associated with the third phase of the first lifecycle definition in addition to the indication of the first case status association with the first lifecycle definition, and automatically initiating the independent execution of the third checklist of the third phase of the second lifecycle definition with respect to the first case instance.

13. The method of claim 12, wherein the execution of the third checklist for the first case instance is initiated after the initiation of the first lifecycle for the first case instance.

14. The method of claim 13, wherein the third checklist executes regardless of the first case status associated with the first case instance.

15. A non-transitory computer readable medium, comprising instructions for:
storing a case model definition, the case model definition comprising:
a hierarchical container model portion, the hierarchical container model portion defining a hierarchical data model, the hierarchical data model representing how case data is organized and comprising a plurality of hierarchically related case nodes;
storing a first lifecycle definition for a first lifecycle for the case model definition, wherein the first lifecycle comprises a first set of phases and a different first case status associated with each of the first set phases;
receiving a first user defined process for a first phase of the first lifecycle definition;
receiving a second user defined process for a second phase of the first lifecycle definition;
generating a first checklist for the first phase of the first lifecycle definition, where the first checklist comprises a first set of ordered tasks corresponding to the first user defined process for the first phase and a first initiating event, and wherein a last task of the first set of ordered tasks of the first checklist is associated with the second phase of the first lifecycle definition;
generating a second checklist for the second phase of the first lifecycle definition, where the second checklist comprises a second set of ordered tasks corresponding to the second user defined process for the second phase and a second initiating event associated with at least one task of the first set of ordered tasks;
creating a first case instance from the case model definition, the first case instance having a first case status;
in response to creation of the first case instance, initiating a first lifecycle of the first lifecycle definition for the first case instance, wherein the first lifecycle is associated with the first case instance;
based on the occurrence of the first initiating event in association with the first case instance, setting the first case status of the first case instance to indicate the first case status associated with the first phase of the first lifecycle definition and automatically initiating the execution of the first checklist of the first phase of the first lifecycle definition with respect to the first case instance;
based on the completion of the last task of the first set of ordered tasks of the first checklist, setting the first case status of the first case instance to indicate the first case status associated with the second phase of the first lifecycle definition; and
in response to the completion of the last task of the first set of ordered tasks, automatically initiating the execution of the second checklist of the second phase of the first lifecycle definition with respect to the first case instance.

16. The non-transitory computer readable medium of claim 15, wherein the tasks are automated or manual tasks.

17. The non-transitory computer readable medium of claim 15, wherein each of the first set of ordered tasks is completed, storing a completed indicator for that task in association with the first case instance, wherein the task may not be indicated as completed until the previous task of the first set of ordered tasks is indicated as completed.

18. The non-transitory computer readable medium of claim 15, wherein the first user define process and the second user defined process are defined in a natural language.

19. The non-transitory computer readable medium of claim 15, wherein the instructions are further for:
receiving a third user defined process for a third phase of the first lifecycle definition, the third phase associated with a second case status;
generating a third checklist for the third phase of the first lifecycle definition, where the third checklist comprises a third set of ordered tasks corresponding to the third user defined process for the third phase of the first lifecycle definition and a third initiating event;
based on the third initiating event association with the third checklist occurring in association with the first case instance, setting the first case status of the first case instance to indicate the second case status associated with the third phase of the first lifecycle definition in addition to the indication of the first case status association with the first lifecycle definition, and automatically initiating the independent execution of the third checklist of the third phase of the second lifecycle definition with respect to the first case instance.

20. The non-transitory computer readable medium of claim 19, wherein the execution of the third checklist for the first case instance is initiated after the initiation of the first lifecycle for the first case instance.

21. The non-transitory computer readable medium of claim 20, wherein the third checklist executes regardless of the first case status associated with the first case instance.
